(19) United States
(12) Patent Application Publication
(10) Pub. No.: US 2016/0025527 A1
(43) Pub. Date: Jan. 28, 2016

(54) Method for Selecting a Field Device for Ascertaining at Least One Process Parameter of a Measured Material in Process and Automation Technology

(71) Applicant: ENDRESS+HAUSER FLOWTEC AG, Reinach (BL) (CH)

(72) Inventors: Ulrich Kaiser, Basel (CH); Juerg Wyss, Ettingen (CH); Roland Muller, Steinen (DE); Joachim Neuhaus, Steinen (DE); Harald Freimark, Lorrach (DE)

(21) Appl. No.: 14/652,893

(22) PCT Filed: Nov. 25, 2013
(86) PCT No.: PCT/EP2013/074610

§ 371 Date: Oct. 7, 2015

(30) Foreign Application Priority Data
Dec. 19, 2012 (DE) 10 2012 112 601.1

(51) Int. Cl. G01D 18/00

(52) U.S. Cl. CPC G01D 18/00

(57) ABSTRACT

A method for selecting a field device for ascertaining at least one process parameter of a measured material in process and automation technology, especially a process parameter such as flow, fill level, limit level, pressure, temperature, conductivity and/or ion concentration of a measured material, which field device is provided at a measuring point of a plant for ascertaining at least one process parameter, characterized by steps as follows: A identifying a first field device, which is suitable to determine the at least one process parameter of the measured material at the measuring point of the plant; B querying a first data set stored in a data memory relative to product features of the first field device, which enable ascertaining the at least one process parameter; C comparing at least one product feature of the first data set of the first field device with at least one corresponding product feature of a second data set of a second field device; and D specifying the second field device, to the extent that there is partial or complete agreement of the product features of the first and second data sets.

The present invention relates to a method for selecting a field device for ascertaining at least one process parameter of a measured material in process and automation technology as defined in the preamble of claim 1, as well as to a data memory as defined in the preamble of claim 10.

Field device selection methods are known, which work with measuring point referenced product features. For this, a user requires very exact information relative to the measuring point where the field device is to be applied. This information is, most often, known only by a limited number of persons.

Cases can arise, however, where a user without comprehensive knowledge of the plant must order a field device, since, for example, a quick reaction to a complete failure of the field device is necessary. On the other hand, there can also be situations, in which a technician knows of a suitable competing device but would like to inquire of other field device manufacturers concerning alternatives. In both cases, a time saving in the field device selection should be achieved.

The present invention achieves this object by a method as defined in claim 1.

A method of the invention for selecting a field device for ascertaining at least one process parameter of a measured material in process and automation technology, especially a process parameter such as flow, fill level, limit level, pressure, temperature, conductivity and/or ion concentration of a measured material, which field device is provided at a measuring point of a plant for ascertaining the at least one process parameter, is characterized by steps as follows:
A identifying a first field device, which is suitable to determine the at least one process parameter of the measured material at the measuring point of the plant;
B querying a first data set stored in a data memory relative to product features of the first field device, which enable ascertaining the at least one process parameter;
C comparing at least one product feature of the first data set of the first field device with at least one corresponding product feature of a second data set of a second field device; and
D specifying the second field device, to the extent that there is partial or complete agreement of the product features of the first and second data sets.

The identification of the first field device and the comparison and specifying of the second field device permits a user to change manufacturers or a to make a product change within the product portfolio of the same manufacturer. This can occur, for example, without additional knowledge of the process requirements just by inputting the device name.

The product features can be, for example, static database values such as the sensor material, however, also dynamically ascertained values such as e.g. the accuracy of measurement at the measuring point

Advantageous embodiments of the invention are subject matter of the dependent claims.

It is advantageous to have the first and second data sets be available in the same data memory. It is, indeed, also an option to have one data set in one data memory and a second data memory manage the comparison data sets; this could, however, lead to increased time consumed when comparing the two data sets.

There can also be users who, with little time to spare, desire a quick comparison of two field devices and their measuring performance as regards certain product features, in order to be able to make an objective buying decision based on the product comparison as regards technical information. Product features include, for example, material properties, measuring ranges, e.g. temperature measurement ranges, or dimensions of the field device, e.g. measuring tube nominal diameters in the case of flow measuring devices. On the other hand, some product features are of no interest for some processes. Therefore, it is advantageous to provide users with a selection opportunity relative to product features. Likewise it is advantageous, when users can weight individual product features. Thus, for example, corrosion resistance in the case of some applications can have a greater weight than the accuracy of measurement of the field device.

It is advantageous when the product features comprise at least parameters, on which the accuracy of measurement of the field device depends. These parameters are in the case of field devices, most often, one of the buy decision variables.

The identification of the first field device can advantageously occur based on input of process parameters, based on a device name, a device type, a manufacturer name and/or an identification number. A corresponding search screen can be shown to the user.

The method can additionally advantageously include an additional step of ascertaining measurement performance parameters of the first and second field devices under process conditions. In this way, the user can be informed, for example, also as regards measurement inaccuracies of the field devices under real conditions. These conditions are stored as empirical results in an additional data set

The identification of the first field device can occur based on a selection list, which is compiled by input of manufacturer name or device types.

For better clarity, the specifying of step D can occur advantageously by visual comparison of the first and second field devices in an output field. The output field can be displayed only on a screen or, in given cases, also be printed out.

According to the invention, a data memory includes a computer program product, which executes a method as claimed in one of claims 1-9.

The invention will now be explained in greater detail based on the appended drawing, the figures of which show as follows:

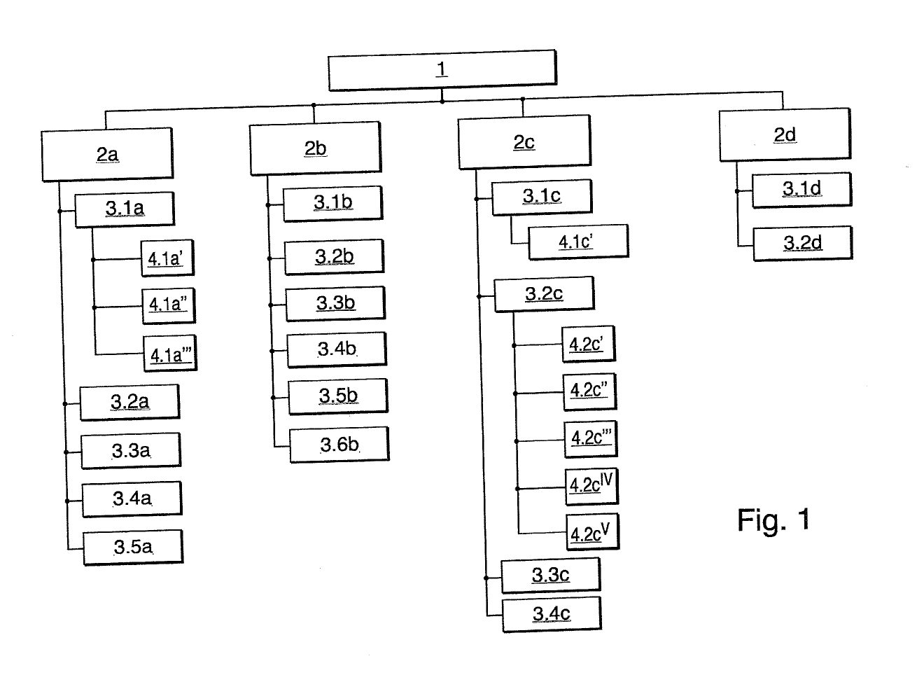

FIG. 1 a flow diagram relative to selection parameters for selecting a field device suitable for a measuring point; and

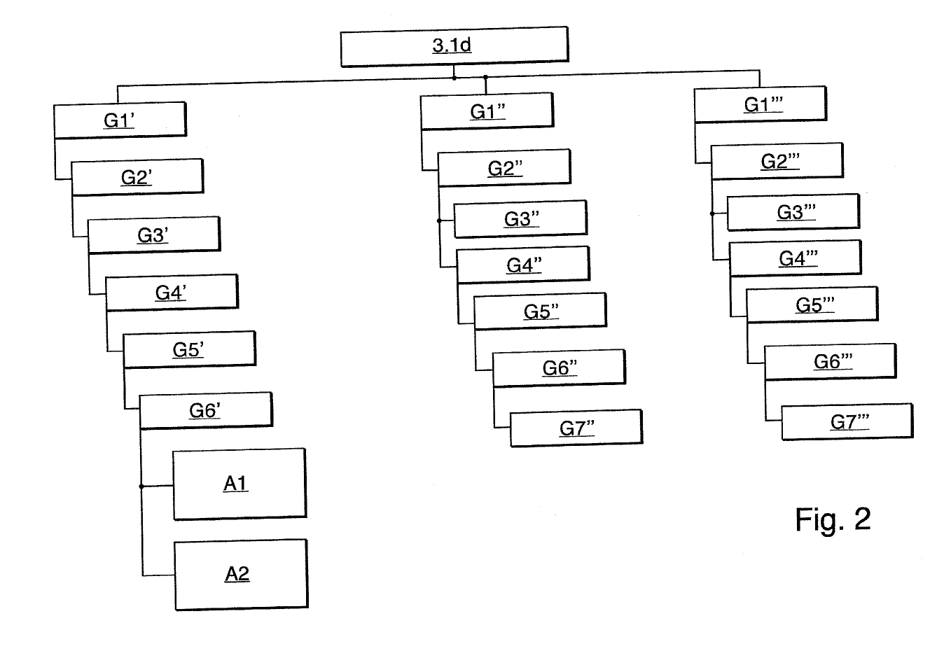

FIG. 2 a flow diagram of individual steps for selecting a field device based on a competitor device, which was utilized previously for the measuring point.

FIG. 1 is a user interface of a display device, which typically is a screen of a is computer, cell phone, tablet-PC or notebook.

Usually, the aforementioned devices make use of volatile and/or non-volatile data memory. Stored durably in a non-volatile data memory can be a computer program product, which permits selection of a suitable field device based on selection parameters.

In automation technology, especially in process automation technology, field devices are often applied, which serve for registering and/or influencing process variables. Serving for registering process variables are sensors, which are integrated, for example, in fill level measuring devices, flow measuring devices, pressure- and temperature measuring devices, pH-redox potential measuring devices, conductivity measuring devices, etc., and register the corresponding process variables, fill level, flow, pressure, temperature, pH-value, respectively conductivity. Serving for influencing process variables are actuators, such as, for example, valves or pumps, via which the flow of a liquid in a pipeline section, respectively the fill level in a container, can be changed. Referred to as field devices are, in principle, all devices, which are applied near to the process and deliver, or process, process relevant information. In connection with the invention, the terminology, field devices, thus means also remote I/Os, radio adapters, respectively, generally, electronic components, which are arranged at the field plane. A large number of such field devices are manufactured and sold by the firm, Endress+Hauser

A field device is, in such case, especially selected from a group composed of flow measuring devices, fill level measuring devices, pressure measuring devices, temperature measuring device, limit level measuring device and/or analytical measuring devices.

The terminology, flow measuring devices, includes, especially, Coriolis, ultrasonic, vortex, thermal and/or magneto inductive flow measuring devices.

The terminology, fill level measuring devices, includes, especially, microwave fill level measuring devices, ultrasonic, fill level measuring devices, time domain reflectometric fill level measuring devices (TDR), radiometric fill level measuring devices, capacitive fill level measuring devices, inductive fill level measuring devices and/or temperature sensitive, fill level measuring devices.

The terminology, pressure measuring devices, includes especially absolute-, relative- or difference pressure measuring devices.

The terminology, temperature measuring devices, includes especially measuring devices with thermocouples and temperature dependent resistors.

The terminology, limit level measuring device, includes, especially, limit level measuring devices based on ultrasonics and/or capacitive limit level measuring devices.

The terminology, analytical measuring devices, includes especially pH-sensors, conductivity sensors, oxygen- and active oxygen sensors, (spectro)-photometric sensors, and/or ion selective electrodes.

FIG. 1 represents a special flow diagram for enabling an end user to select a flow measuring device. This flow diagram is present in the form a computer program product in a data memory. The data memory can be, for example, in the case of so-called cloud applications, a network capable computer, in which the computer program is managed. It can, however, also be temporarily or durably resident in a data storage unit, i.e. a RAM or ROM.

Selection programs for field devices, such as the so-called Applicator tool of Endress+Hauser, belong, in the case of many companies, to the state of the art and can be queried via company networks or even freely via the Internet. These programs facilitate for a technician, either via special selection criteria designed for specialists or via selection criteria designed for a beginner mode, the technically quite difficult decision for buying a suitable field device for the particular special field of application.

The selection criteria illustrated in FIG. 1 can be queried individually or in combination and will be explained below in greater detail. The user is, first of all, presented with a start field, respectively selection field, 1, with which it can start the computer program product.

In such case, a selection can occur based on product catalogs 2a of the manufacturer. The product catalogs are furnished in the form of data sets for each individual field device.

The data sets comprise especially static database values such as the sensor material of the field device, however, also dynamically ascertained values such as e.g. the accuracy of measurement of the field device at the design point. In the case of flow measuring devices, these values concern preferably company-specific device type names 3.1a, flange types 3.2a, nominal diameters and tube materials 3.3a, tube connections, the fluids 3.4a to be measured and units 3.5a, in which the measuring should occur.

Company specific device type names can include, for example, names such as t-mass, Prosonic Flow, Promass, Promag, Prowirl, etc., such as are used for typical devices and, in given cases, also as brand names in field specific customer groups.

Given as flange types can be, for example, food flanges or also flangeless-combinations, which can be integrated into PE-tube systems by welded connections.

Tube materials are materials of measuring tubes of the flow measurement field, which, for example, depending on field of application, can be stainless steel, aluminum or a synthetic material, such as PE. Also, the linings of the measuring tube, the so-called liner, and its material composition are furnished as a data set for the particular flow measuring device.

Tube connections can be, for example, in the case of PE tubes, so-called E-sleeves.

Fluids include essentially conducting and non-conducting fluids, thus e.g. water or oil, additionally, gases and vapors. A magneto-inductive flow measuring device, for example, cannot measure non-conducting liquids, gas and vapors.

Some devices provide mass- or volume flow as the measured values. This can be taken into consideration in the selection.

Correspondingly, these data sets, which are furnished in the form of product catalogs, permit the end user to make a selection.

Starting from the aforementioned start field 1, the end user can additionally find access to the products of the manufacturer via a measurement principle selection 2b.

Preferably relative to the measurement principle selection 2b, the selection fields can subdivide into subcategories such as fill level 3.1b, flow 3.2b, pressure 3.3b, temperature 3.4b, energy 3.5b or analysis 3.6b.

Granted, energy and analysis do not concern pure measuring principles but rather application fields. It is, however, the case that the end customer can also make a selection according to application fields. Measuring principles and application fields can, consequently, also be associated with a shared category.

A further selection field of an Applicator tool lies in calculation modules 2c. These modules enable determining, in the case of selection of the corresponding fluid properties 3.1c, which of such are, in given cases, to be ascertained according to determined industry standards 4.1c. This relates e.g. to the NAMUR standard, so that a preselection according to NAMUR conforming devices can be made. In the case of known process parameters, a user can apply device designs 3.2c, such as pressure 4.2c′, fill level 4.2c″, flow 4.2c″′, temperature 4.2c^{iv} and energy^{v}, to make its buy decision as regards a suitable device. The Applicator tool can in this connection also offer a units conversion 3.3c. Furthermore, under the option calculating modules 2c, also an ascertaining of measurement performance parameters 3.4c of a field device in a plant under process conditions can be is conducted. Preferably this concerns specifying an ascertained accuracy of measurement at the design point. For this, data relative to variable process parameters, such as e.g. pressure- and/or temperature losses, are queried and/or given and the data corrected by the process-related measurement performance parameters enter into the device selection.

A further selection field illustrated in FIG. 1 relates to comparison operations 2d. Here, particular process conditions can be entered directly, key word like, and the Applicator tool assembles a selection of devices, which have the keyword. A typical keyword can be e.g. “corrosion resistant”.

The aforementioned features and functions of the Applicator tool of Endress+Hauser are known per se and are already utilized and serve to explain the fundamental construction of an Applicator tool. There are, however, also Applicator tools known, which have other categories in selection fields and their subcategories and, in given cases, are supplemented by other selection functions.

An Applicator tool of the invention includes, moreover, another function, which will now be described. This function is presented in FIG. 2 as a subcategory of the selection field “comparisons” 2.d and can be referred to as “profile comparison” 3.1d.

This profile comparison will now be explained in greater detail.

Stored on a data carrier temporarily or persistently are data sets for a competing field device. These data sheets are, as a rule, freely available or are delivered from the competing manufacturers upon query.

Upon input of a name of a competing field device or at least a part of the name of the competing field device, the data set of such field device is downloaded and compared with the furnished product catalog of the manufacturer field devices.

In the case of agreement of the data sets of both products, thus of the competing field device and of the manufacturer field device, the manufacturer product is output as the suitable field device. It can also happen that different manufacturer field devices prove suitable for replacing the competing field device.

This simple procedure enables a customer, without more exact data for measuring conditions, process parameters and application domain, quickly to make a selection.

There are situations in process technology, where one must react very quickly in the case of damage, thus in the case of complete failure of the field device. In case the competing device manufacturer cannot, however, quickly deliver a replacement, the present computer program product enables a plant technician without a great amount of background knowledge concerning the process, quickly to order a replacement and to profit from the, in given cases, shorter delivery times of another device manufacturer.

Moreover, the comparison function of the product specific data sets of a competing field device and a manufacturer field device enables the purchase of field devices more appropriate for the measuring point.

This will now be explained in greater detail based on the flow diagram of FIG. 2

FIG. 2 shows the selection option of the Applicator tool for entering into the subcategory “competitor device” 3.1.d. In the subcategory “direct comparison” G1′, the user can retrieve a comparison between a manufacturer field device and a competing field device.

In this case, the input of the competing field device name G2′ can occur, for example, the name of a flow measuring device.

After input of the competing field device name, there occurs a comparison operation by a computing unit, as well as the comparison of both devices, that of the manufacturer and the competing device. In the case of essentially overlapping device parameter ranges, an entering G3′ of a manufacturer field device onto a is selection list G4′ can occur.

Since the measuring performance was measured under manufacturer dependent reference conditions, the comparison operation can occur likewise based on reference conditions G5′.

It is in the case of specifying certain process parameters also possible to perform an ascertainment of measuring performance, respectively measuring features, under process conditions G6′. For this, however, process data are required, which are harmonized with furnished data sets, respectively calculating algorithms, for diverse process situations.

These data sets, respectively calculating algorithms, for process situations come from empirical measurement data, which were recorded e.g. in the case of flow measuring devices in comparative measurements in corresponding process plants.

Based on this data, the Applicator tool can assemble a selection of candidate field devices for real conditions. The field devices can be directly compared by the user based on their product parameters through visual comparison of the manufacturer product A1 and the competing product A2.

It can occur that a user is interested not only in meeting but, instead, also in a special improving of a device parameter while otherwise keeping remaining device parameters the same.

For this selection, for example, an input of different process parameters such as process pressure, temperature, etc. can occur or certain process features ascertained based on plant parameters. The user can directly input these into the Applicator tool.

These are available according to reference conditions in the Applicator tool, so that a retrieving of process data at reference conditions G4′ can occur.

Then, a comparison G6′ can occur with the parameter output of the manufacturer field device A1 and the competing field device A2 preset by the user, so that it is is clear to the user, which of the two devices has a better measuring performance.

In such case, also the product parameters can be compared by ascertaining variable measurement performance parameters G5′ of the field device relative to one another as a function of process conditions.

The selection fields G3″-G7″ and G3′″-G7″′ are analogous to the selection fields G4′-G7′ and. However, the data access occurs differently.

In the field G1″, the option “manufacturer field device” can be selected and a manufacturer field device name input. Then, the output of a list of competitor field devices G2″ occurs for the purpose of product comparison.

In the field G1′″, an accepting of the process data input into the Applicator tool can occur, along with a display of possible manufacturer field devices and competing field devices in the context of a product comparison.

These latter functions enable a user to perform a time-consuming individual comparison covering different manufacturers.

The computer program product can be provided to the user as a Web-based solution, for example, in the form of a Java server page. It can, however, also be made available for optimally rapid access as an app for cell phones or tablet PC's and portable PC's.

Ideally, the comparison function and other functions of the Applicator tool can be made available in the form of tender text recognition, so that a printout, for example, by a service technician of the field device manufacturer can go to an end customer as an offer on the basis of the search results.

The Applicator tool, consequently, formats the strengths and weaknesses of the competitor field devices and the manufacturer field devices in a manner, which enables a user to make a quick buy decision

1-10. (canceled)

11. A method for selecting a field device for ascertaining at least one process parameter of a measured material in process and automation technology, especially a process parameter such as flow, fill level, limit level, pressure, temperature, conductivity and/or ion concentration of a measured material, which field device is provided at a measuring point of a plant for ascertaining at least one process parameter, the steps of:
identifying a first field device, which is suitable to determine the at least one process parameter of the measured material at the measuring point of the plant;
querying a first data set stored in a data memory relative to product features of the first field device, which enable ascertaining the at least one process parameter;
comparing at least one product feature of the first data set of the first field device with at least one corresponding product feature of a second data set of a second field device; and
specifying the second field device, to the extent that there is partial or complete agreement of the product features of the first and second data sets.

12. The method as claimed in claim 11, wherein:
the first and second data sets are available in the same data memory.

13. The method as claimed in claim 11, wherein:
said comparison step includes at least product features, which were selected earlier by a user.

14. The method as claimed claim 11, wherein:
a weighting of individual product features is predetermined by the user and taken into consideration in said comparison step.

15. The method as claimed in claim 11, wherein:
the product features comprise at least parameters, on which the measurement accuracy of the field device depends.

16. The method as claimed in claim 11, wherein:
said identification of the first field device occurs based on input process parameters, based on a device name, a device type, a manufacturer name and/or an identification number.

17. The method as claimed in claim 11, further comprising the step of:
an additional step of ascertaining measurement performance parameters of the first and second field devices under process conditions.

18. The method as claimed in claim 11, wherein:
said identification of the first field device occurs based on a selection list compiled by input of the manufacturer name or device type.

19. The method as claimed in claim 11, wherein:
said specifying occurs by visual comparison of the first and second field devices in an output field.

20. A data memory having a computer program product, which executes a method, comprising the steps of: a method for selecting a field device for ascertaining at least one process parameter of a measured material in process and automation technology, especially a process parameter such as flow, fill level, limit level, pressure, temperature, conductivity and/or ion concentration of a measured material, which field device is provided at a measuring point of a plant for ascertaining at least one process parameter, the steps of: identifying a first field device, which is suitable to determine the at least one process parameter of the measured material at the measuring point of the plant; querying a first data set stored in a data memory relative to product features of the first field device, which enable ascertaining the at least one process parameter; comparing at least one product feature of the first data set of the first field device with at least one corresponding product feature of a second data set of a second field device; and specifying the second field device, to the extent that there is partial or complete agreement of the product features of the first and second data sets.
